(19) United States
(12) Patent Application Publication
(10) Pub. No.: US 2026/0253079 A1
(43) Pub. Date: Aug. 27, 2026

(54) SYSTEM AND METHOD FOR A DIGITAL WALLET

(71) Applicant: QUANATA, LLC, San Francisco, CA (US)

(72) Inventors: Eric Christopher Dahl, Newman Lake, WA (US); Andrew George Fishel, Chicago, IL (US); Carlton Wayne Rice, II, Pflugerville, TX (US); Brandon Gredler, Austin, TX (US); Aaron D. Shimer, Evanston, IL (US); Paula Adams, San Francisco, CA (US); Andrew Glenn Gregory, San Francisco, CA (US); Scott Murray Anderson, Stanwell Park (AU)

(73) Assignee: QUANATA, LLC, San Francisco, CA (US)

(21) Appl. No.: 19/065,287

(22) Filed: Feb. 27, 2025

(51) Int. Cl. G06Q 20/40; G06F 21/62; G06Q 20/36

(52) U.S. Cl. CPC G06Q 20/4016; G06F 21/6245; G06Q 20/363; G06Q 20/4014

(57) ABSTRACT

A method for revoking access to personal information. The method can include obtaining personal data of a user. The method further can include storing the personal data in a digital wallet. The method also can include determining that at least a portion of the personal data in the digital wallet is subject to a data security risk. The method additionally can include transmitting for display on a device of the user, an alert regarding the data security risk and a control to revoke access to the at least the portion of the personal data. Other embodiments are disclosed.

### FIELD OF THE DISCLOSURE

The present disclosure generally relates to digital wallets.

### BACKGROUND

Losing personal data can lead to significant risks, including identity theft, financial loss, and damage to one's reputation. When personal information is exposed, criminals can exploit this data for fraud or blackmail. Victims may face unauthorized transactions, loans taken out in their name, or even legal issues. Overall, the consequences of a data breach can be severe, affecting both personal and professional aspects of an individual's life. Therefore, a digital wallet that allows the user to manage access to his personal information and proactively protect his personal information is desired.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a system for a digital wallet;

FIG. 4 illustrates a flow chart for using the digital wallet, according to one exemplary embodiment;

FIG. 5 illustrates exemplary user interface displays of the digital wallet; and

FIG. 6 illustrates an exemplary user interface display showing an alert.

The figures depict preferred embodiments for purposes of illustration only. One skilled in the art will readily recognize from the following discussion that alternative embodiments of the systems and methods illustrated herein can be employed without departing from the principles of the invention described herein.

### DETAILED DESCRIPTION OF THE DRAWINGS

The present embodiments can generally relate to, inter alia, protecting a user's personal data. The system is capable of obtaining personal data of a user and storing it in a digital wallet. The system can determine that the user's personal data is compromised or subject to a security risk and alert the user. Through the system, the user can control access to his personal data by granting access to third parties and revoking that access to third parties.

More specifically, various embodiments can include a system for revoking access to personal information. The system may include one or more processors and one or more non-transitory computer-readable media storing computing instructions. The computing instructions, when executed on the one or more processors, cause the one or more processors to perform operations comprising: obtaining personal data of a user; storing the personal data in a digital wallet; determining that at least a portion of the personal data in the digital wallet is subject to a data security risk; and transmitting for display on a device of the user, an alert regarding the data security risk and a control to revoke access to the at least the portion of the personal data. The non-transitory computer-readable media can be configured to include additional, less, or alternate functionality, including that discussed elsewhere herein.

In another aspect for a method for revoking access to personal information, the method comprises: obtaining personal data of a user; storing the personal data in a digital wallet; determining that at least a portion of the personal data in the digital wallet is subject to a data security risk; and transmitting for display on a device of the user, an alert regarding the data security risk and a control to revoke access to the at least the portion of the personal data. The method can include additional, less, or alternate steps, including that discussed elsewhere herein.

In another aspect, a computer readable storage medium storing computing instructions can be provided. The computing instructions, when run on one or more processors, can cause the one or more processors to perform operations comprising: obtaining personal data of a user; storing the personal data in a digital wallet; determining that at least a portion of the personal data in the digital wallet is subject to a data security risk; and transmitting for display on a device of the user, an alert regarding the data security risk and a control to revoke access to the at least the portion of the personal data. The computer readable storage medium can be configured to include additional, less, or alternate functionality, including that discussed elsewhere herein.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

Personal data, as mentioned above, can include identifying information such as name, birthday (and age), address, social security number, phone number, email address, etc. Identifying information can be found on an identification card, driver's license, passport, national ID card. Personal data can also include financial details such as bank account information (account numbers, bank names, etc.), credit and debit card details (card numbers, expiration dates, CVV codes), insurance information (policy numbers, coverage details, premium amounts, etc.), tax information (tax returns, tax identification numbers, tax payment records, etc.). Personal data may also include credentials such as security tokens (two-factor authentication, etc.), professional qualifications (degrees, certifications, licenses, etc.), insurance cards, and other credentials such as a safe driving credential, a wholesale club membership, gym membership, a rewards program member, vaccination card, TSA-pre check user, etc.

### Exemplary Computer Systems

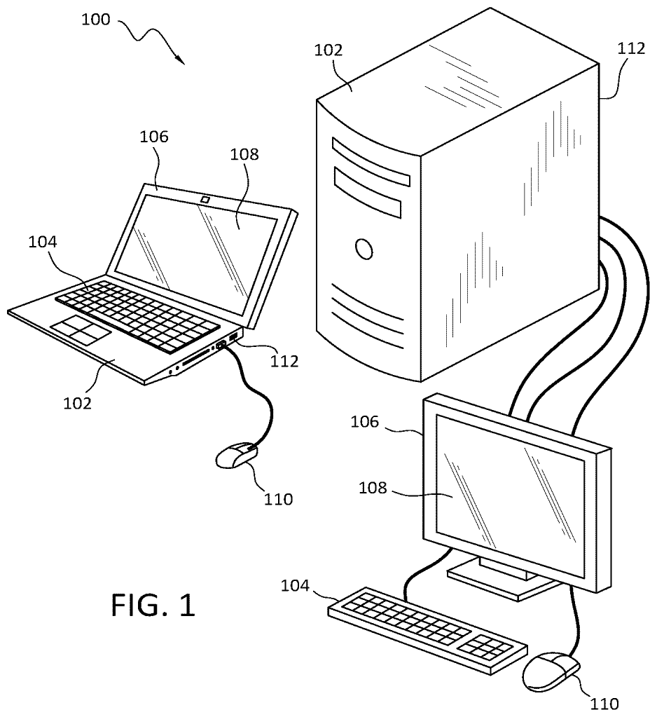

Turning to the drawings, FIG. 1 illustrates an exemplary embodiment of two different types (e.g., a laptop and a tower server) a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

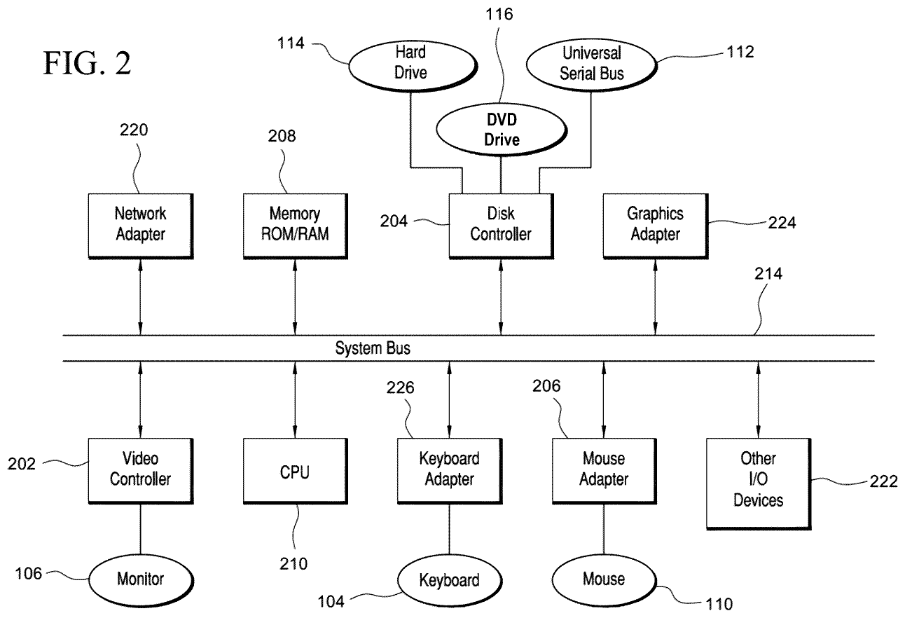

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in CD-ROM and/or DVD drive 116 (FIG. 2) inside chassis 102 (FIG. 1) or in a detachable drive coupled to input/output port 112 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable drive coupled to input/output port 112 (FIGS. 1-2), on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, wearable, virtual reality headset, augmented reality glasses, etc. In certain additional embodiments, computer system 100 can comprise an embedded system.

### Exemplary Computer Systems for a Digital Wallet

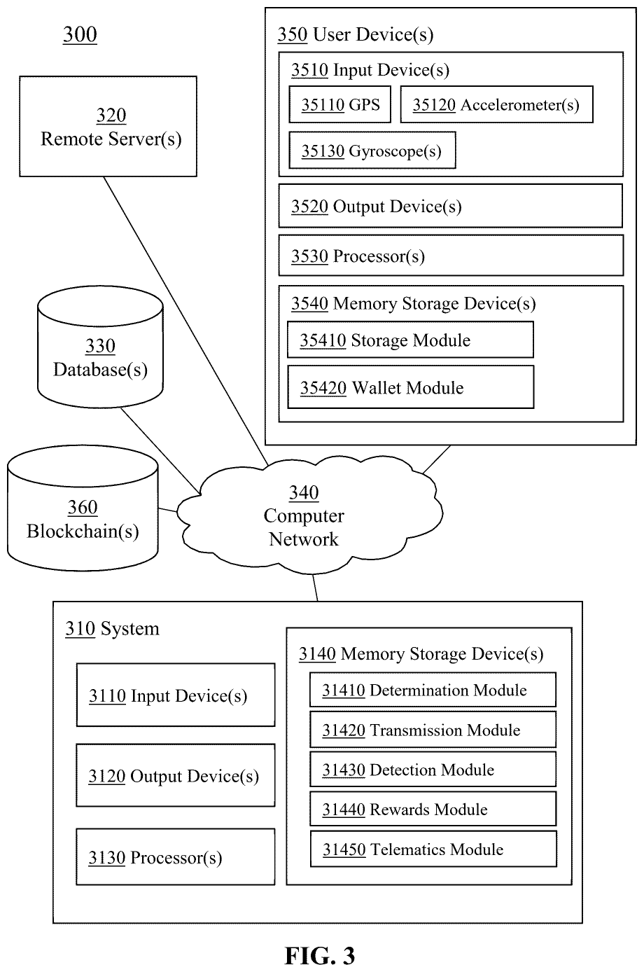

Turning ahead in the drawings, FIG. 3 illustrates a block diagram of a system 300 for revoking access to personal information according to one embodiment. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), remote server(s) 320, and/or one or more user devices (e.g., a user device 350). System 310 and user device 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310 and user device 350.

In many embodiments, system 310 can be modules of computing instructions (e.g., software modules) stored on non-transitory computer readable media that operate on one or more processors. In other embodiments, system 310 can be implemented in hardware. In many embodiments, system 310 can comprise one or more systems, subsystems, modules, models, or servers (e.g., a determination module 31410, a transmission module 31420, a detection module 31430, a rewards module 31440, a telematics module 31450, etc.). Each of determination module 31410, transmission module 31420, detection module 31430, rewards module 31440, and telematics module 31450, and wallet module 31460 can be implemented, at least in part, in software and/or firmware stored in or loaded on memory storage device(s) 3140 and executed on processor(s) 3130. Additional details regarding system 310, remote server(s) 320, and user device(s) 350 are described herein.

In some embodiments, system 310 can be in data communication, through a computer network, a satellite network, a telephone network, or the Internet (e.g., computer network 340), and/or user device 350. In some embodiments, user device 350 can be used by users, such as users for system 310 and/or user device 350.

In certain embodiments, system 310 can host one or more websites and/or mobile application servers. For example, system 310 can host a website, or provide a server that interfaces with an application (e.g., a mobile application or a web browser), on user device 350, which can allow users to sign up for a digital wallet, to store their person data in the digital wallet, to sign up for determining that at least a portion of the personal data in the digital wallet is subject to a data security risk, and to alerts regarding the data security risks/revoking access to the at least the portion of the personal data. In some embodiments, an internal network (e.g., computer network 340) that is not open to the public can be used for communications between system 310, remote server(s) 320, and/or user device 350 within system 300.

In many embodiments, each of user device(s) 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras and/or one or more microphones. In the same or different embodiments, input device(s) 3510 can include one or more GPS (Global Positioning System) sensor(s) (e.g., GPS sensor(s) 35110), one or more accelerometers (e.g., accelerometer(s) 35120), and/or one or more gyroscopes (e.g., gyroscope(s) 35130). In the same or different embodiments, user device(s) 350 can comprise one or more systems, subsystems, modules, models, or servers (e.g., a storage module 35410, a wallet module 35420, etc.). Each of storage module 35410 and wallet module 35420 can be implemented, at least in part, in software and/or firmware stored in or loaded on memory storage device(s) 3540 and executed on processor(s) 3530.

In many embodiments, user device 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc.

Input device(s) 3510 and output device(s) 3520 can be coupled to user device 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device 350. In a similar manner, processor(s) 3530 and/or memory storage device(s) 3540 can be local and/or remote to each other.

In certain embodiments, the user devices (e.g., user device 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, etc.), (b) one or more display devices (e.g., output device(s) 3120 such as one or more monitors, one or more touch screen displays, projectors, etc.), (c) one or more processors (e.g., processor(s) 3130), and/or (d) one or more memory storage devices (e.g., memory storage device(s) 3540 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 3130) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output port 112 (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., a database(s) 330) and/or blockchain (blockchain(s) 360). The one or more databases can include a member database that contains information about the demographic, geographic, and/or psychographic information of members of a population (e.g., insurance policyholders for an insurance company, etc.). The demographic, geographic, and/or psychographic information of the members can include the ages, genders, weights, residences, insurance policies, premiums, driving behavior data, payment history, and/or claim histories for the members, for example, among other information. The one or more databases additionally can include one or more of trained machine learning (ML) and/or artificial intelligence (AI) models (the ML/AI models) used in system 300 and/or system 310. The one or more databases further can include training datasets for various ML/AI models, modules, or systems, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc. ; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

### Exemplary Methods for Using a Digital Wallet

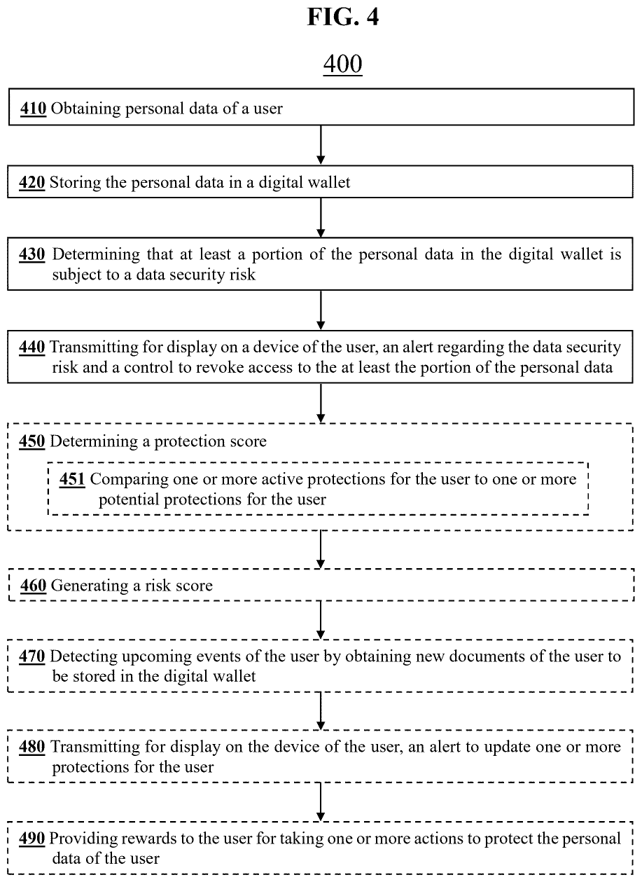

Turning ahead in the drawings, FIG. 4 illustrates actions of a method 400 for revoking access to personal information. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In many embodiments, system 300 or system 310 (FIG. 3) (including one or more of its elements, modules, and/or systems, such as determination module 31410, transmission module 31420, detection module 31430, rewards module 31440, telematics module 31450, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or system 310. The processor(s) can be similar or identical to the processor(s) described above with respect to computer system 100 (FIG. 1).

Referring to FIG. 4, in many embodiments, method 400 can include a block 410 of obtaining personal data of a user. Personal data of the user can be obtained through surveys and questionnaires. For example, the user may fill in the blanks that request for their personal information when signing up for their digital wallet.

Personal data of the user can also be obtained via online tracking and the information stored in the internet browser (e.g. Microsoft Edge, Google Chrome, Mozilla Firefox, etc.). The browser history and the cookies stored in the internet browser can be used to determine whether the user has an account with certain websites for social media, banking, gaming, etc. The personal data of the user can be obtained through the usernames and passwords saved on the internet browser of the user.

The user may also share his personal data from financial institutions, websites, applications, etc. For example, the user may sign in through an online portal and authorize the release or sharing of his personal data stored by the financial institutions, websites, or applications.

In many embodiments, method 400 further can include a block 420 of storing the personal data in a digital wallet. The personal data can be stored in a digital wallet and secured via encryption. The personal data can also be tokenized. The digital wallet may also utilize a dedicated secure chip within user device(s) 350 to store the information so that it is isolated from the main operating system so that the digital wallet is not accessible through compromised user device(s). A self-sovereign identity (SSI) model may be used to store and manage the user's personal information so that only the user can decide when, how, and with whom to share his personal data with.

An SSI model addresses the vulnerabilities and inefficiencies of current centralized data storage and credential verification systems. Current systems are highly susceptible to cyberattacks and can be unreliable when critical verifications are required. Additionally, the credential verification process in these systems is often time-consuming, leading to an increase in fraudulent IDs and unchecked certifications.

In contrast, SSI models improves online security by giving users control over their own identities, eliminating the need for centralized databases that can be hacked or become inaccessible.

SSI models involve decentralized identifiers (DIDs), which are globally unique identifiers built on decentralized databases. Unlike traditional identifiers that rely on centralized databases, DIDs operate on the decentralized blockchain framework, eliminating the need for a central authority. This allows individual identification and verification on the blockchain. DIDs utilize encryption and decryption technology, making them cryptographically verifiable and do not contain personally identifiable information to enhance privacy and security. DIDs are created, owned, and controlled by the user(s). This offers the technical benefit for user's to directly control their personal data, rather than rely on a centralized database where a third party has the ultimate authority when it comes to control.

The personal data may also only be accessible via biometric authentication. For example, fingerprint or facial recognition technology may be used. Other technologies such as passcodes, passwords, patterns and/or duo authentication may be used. For example, the user may provide biometric authentication in order to control access and sharing of the personal data stored.

In many embodiments, the stored personal data may be shared by the user (or holder) with other parties (the verifier) such as merchants, insurance providers, consumer report providers, etc. The user can select/authorize which portions of his personal data he would like to share with each party. For example, the user may choose to only share one of his many credit cards/payment methods with one merchant along with his residential address. The user may then share his social security number with a consumer report provider along with his employment details.

In other embodiments, the other party (verifier) can confirm the authenticity and validity of holder's credentials by directly interacting with an issuer. The issuer is often an organization or accredited individual responsible for creating and issuing the holder's credentials. The issued holder's credentials may be digitally signed and/or cryptographically verifiable.

In a number of embodiments, method 400 also can include a block 430 of determining that at least a portion of the personal data in the digital wallet is subject to a data security risk. Determining that at least a portion of the personal data in the digital wallet is subject to a data security risk may be done by monitoring for unusual activity such as multiple failed login attempts, access from unfamiliar locations, unusual transactions.

Unusual transactions may be detected by monitoring for unusually large, frequent, or complicated transactions. For example, an algorithm can be used to learn the user's spending habits. The algorithm may determine that a transaction is larger than a threshold, too frequent, the transaction is foreign without prior transactions indicating travel (airfare, train fare, hotel fees, etc.), or that the transaction amount is unusual for the category (e.g. $5,000 at a florist).

Unusual transactions may also be detected when transactions occur simultaneously or in rapid succession, or/and in combination across different geographical locations. For example, a transaction may take place in Bloomington, IL and Phoenix, AZ in a short time period.

Further, unusual transactions may be detected when the receiver of the transaction has a short account history. The receiving account may be made in the previous minute, hour, day, or week. The receiving account may also have none or little activity prior to the unusual transaction.

In many embodiments, method 400 further can include a block 440 of transmitting for display on a device of the user, an alert regarding the data security risk and a control to revoke access to the at least the portion of the personal data. For example, the alert may be a notification, a text message, an email, a phone call. The notification may be accompanied with a chime or a vibration.

In various embodiments, access to at least the portion of the personal data may be revoked by the user revoking or rotating the API key(s) or token(s) associated with the other party. In other embodiments, the other party's permissions to access may be revoked so that they no longer have access. In some embodiments, the user can update the permissions in the digital wallet by updating the status of the verifiable credential through the blockchain(s) 360. For example, the status of the verifiable credential may be updated to “revoked” on the blockchain(s) 360.

Verifiable Credentials (VCs) are tamper-evident, cryptographically secure digital credentials used to verify specific claims about an individual or entity. Issued by trusted authorities (issuer), VCs enable the holder to selectively disclose only the necessary information, ensuring privacy and control over personal data. Unlike traditional credentials, VCs can be instantly and independently verified through cryptographic methods, enhancing trust and security in digital interactions.

In many embodiments, method 400 further can include a block 450 of determining a protection score. Block 450 may further include a block 451 of comparing one or more active protections for the user to one or more potential protections for the user. The potential protections of the user may be determined based on the user's life events such as trips, age, finances, etc. For example, if the user has a boarding passed stored in his personal wallet, travel insurance may be considered a potential protection for the user. In another example, if the user is of a certain age, or the user works in a certain profession deemed to be dangerous, life insurance may also be considered a potential protection. The score may be calculated as a percentage or as a number/rating. For example, if the user has life insurance, auto insurance, homeowner's insurance, and travel insurance, his protection score can be 400. The weighting of each category of protection may be weighed equally or differently. In additional or alternatively, the user's protection score can be 80% because he is missing flood insurance and/or health insurance.

In several embodiments, method 400 further can include a block 460 of generating a risk score. The risk score can be generated based in part on a driving score and/or the protection score. The driving score is determined based at least in part on the telematics data of the user. For example, telematics sensors on the input device(s) may collect data on the speed, use, cornering, braking, etc. of the user when the user is driving through various input device(s) 3510. The protection score and the driving score can be used in combination to generate a risk score. For example, averaging may be used. The protection score and the driving score does not need to carry equal weight in the calculation of the risk score. For example, the driving score may carry a weight of 0.9 and the protection score may carry a weight of 0.1.

In several embodiments, method 400 further can include a block 470 of detecting upcoming events of the user by obtaining new documents of the user to be stored in the digital wallet. For example, when a boarding pass or a hotel key is stored in the digital wallet of the user, a vacation or business trip may be detected. When the address of the user's identification card changes, it can be detected that the user has moved to a new house or rental property. In another example, when the user adds a new insurance policy such as for an automobile, it can be detected that the user has purchased a new car or modified his car insurance. In other embodiments, the user may provide information on his upcoming events. For example, the user may be asked if he is traveling in the near future and if the answer is yes, then it can be detected that the user is traveling soon.

In several embodiments, method 400 further can include a block 480 of transmitting for display on the device of the user, an alert to update one or more protections for the user. For example, the alert may be a notification, a text message, an email, a phone call. The notification may be accompanied with a chime or a vibration. The notification may suggest additional or replacement protections for the user.

In several embodiments, method 400 further can include a block 490 of providing rewards to the user for taking one or more actions to protect the personal data of the user. The user may be provided monetary rewards and digital badges. The user may protect his personal data by revoking access to portions of his personal data, and enabling two-factor authentication on his various accounts on social media, financial institutions, etc. The user may also protect his personal data by reviewing the alerts generated regarding the data security risk and/or by watching educational videos to keep up to date with the latest security threats and best practices.

In other embodiments, the user may be provided discounts, vouchers, gift cards, merchandise, travel miles, and/or entries for raffles when he acquires potential protections or switches protections. For example, the user is provided with a reward for switching auto insurance providers. In another example, the user is provided with a reward for acquiring life insurance when he previously did not have life insurance.

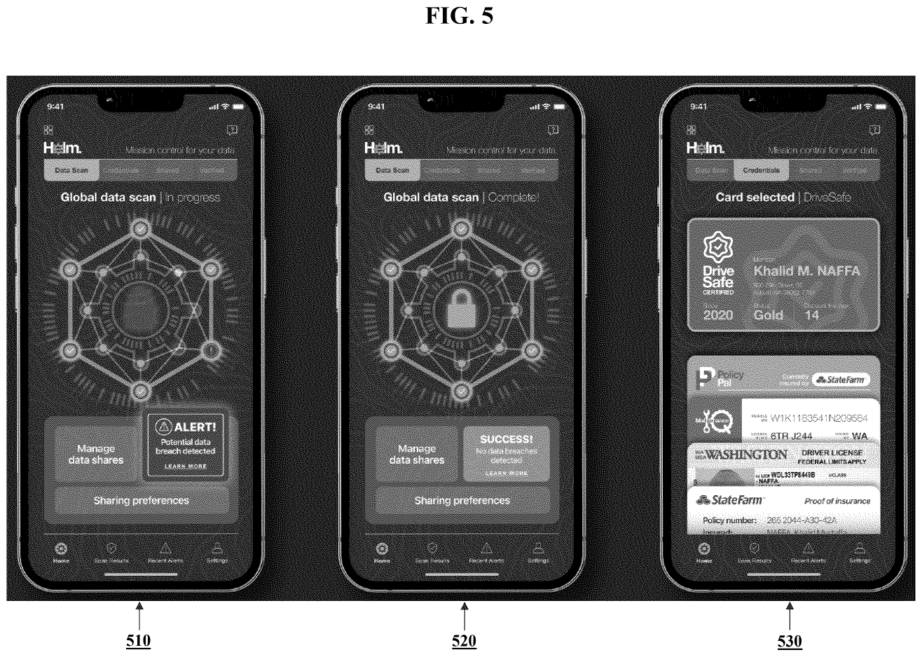

Referring to FIG. 5, user interface display 510 is an example of a display provided by the user interface, which contains a graphic to display how secure the user's personal information is. When the lock is red, it shows that at least a portion of the user's personal information may be compromised. There may be text explaining that at least a portion of the user's personal information may be compromised, and the user may learn more by selecting the text or accompanying text/button. Additionally, the green/red dots may represent protections (auto insurance, life insurance, health insurance, etc.) that the use has in green, and the user is missing or is a potential protection.

User interface display 520 is an example of a display provided by the user interface, showing that the user's personal information is secure and/or that the user's personal information is not compromised. There may be text explaining that the user's personal information is secure and/or that the user's personal information is not compromised, and the user may learn more by selecting the text or accompanying text/button. Additionally, the green/red dots may represent protections (auto insurance, life insurance, health insurance, etc.) that the use has in green, and the user is missing or is a potential protection.

User interface display 530 is an example of a display provided by the user interface, showing the storage of the user's credentials. For example, stored certificates, insurance policies, passports, driver licenses, vaccination cards, employment, and payment options may be displayed under a credentials section.

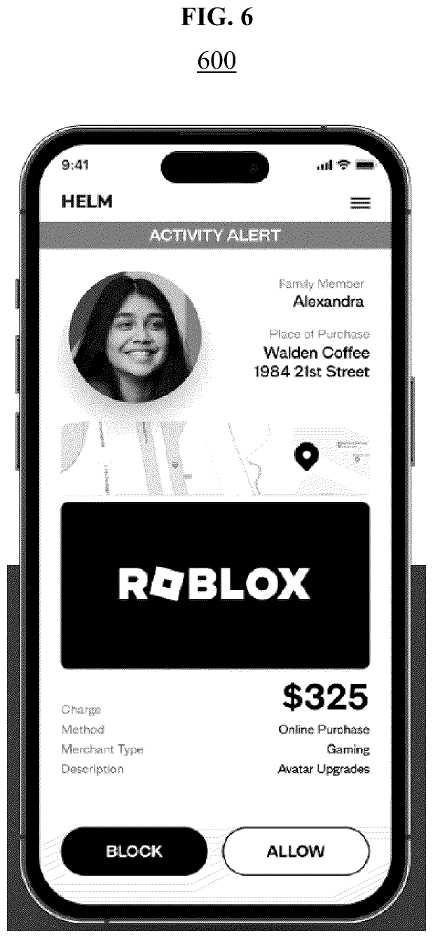

Referring to FIG. 6, user interface display 600 is an example of a display of the user interface for monitoring the online transactions of family members. The alert may display the person who triggered the alert, where the alert was triggered, and details of the alert such as the amount charged, category of purchase, method of payment, and description of the alert. The user may also have the option to select whether to block or allow the activity by selecting the “block” button or the “allow” button.

Relating FIG. 4 to FIG. 3, as an example, determination module 31410 (FIG. 3) can perform blocks 430, 450, and 460; transmission module 31420 (FIG. 3) can perform blocks 410, 440 and 480; detection module 31430 (FIG. 3) can perform block 470; reward module 31440 (FIG. 3) can perform block 490; telematics module 31450 (FIG. 3) can perform block 470, wallet module 35420 can perform block, and storage module 35410 can perform block 420.

### Additional Considerations

Although a digital wallet has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-6 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for revoking access to personal information, the system comprising:
one or more processors; and
one or more non-transitory computer-readable media storing computing instructions that, when executed on the one or more processors, cause the one or more processors to perform operations comprising:
obtaining personal data of a user;
storing the personal data in a digital wallet;
determining that at least a portion of the personal data in the digital wallet is subject to a data security risk; and
transmitting for display on a device of the user, an alert regarding the data security risk and a control to revoke access to the at least the portion of the personal data.

2. The system in claim 1, wherein the operations further comprise:
determining a protection score comprising:
comparing one or more active protections for the user to one or more potential protections for the user, wherein the one or more potential protections for the user are determined based in part on upcoming events of the user and demographic information of the user.

3. The system in claim 2, wherein the operations further comprise:
generating a risk score, wherein the risk score is generated based at least on a driving score and the protection score, and wherein the driving score is based at least on telematics data of the user.

4. The system in claim 1, wherein:
the digital wallet stores one or more safe driving certifications when a driving score of the user meets a score threshold; and
the driving score is based in part on telematics data of the user.

5. The system in claim 1, wherein the operations further comprise:
detecting upcoming events of the user by obtaining new documents of the user to be stored in the digital wallet; and
transmitting for display on the device of the user, an alert to update one or more protections for the user.

6. The system in claim 1, wherein the operations further comprise:
providing rewards to the user for taking one or more actions to protect the personal data of the user.

7. The system in claim 1, wherein the digital wallet further stores at least one of:
one or more payment methods for making purchases; or
one or more forms to enter personal information of the user.

8. A computer-implemented method for revoking access to personal information, the computer-implemented method comprising:
obtaining personal data of a user;
storing the personal data in a digital wallet;
determining that at least a portion of the personal data in the digital wallet is subject to a data security risk; and
transmitting for display on a device of the user, an alert regarding the data security risk and a control to revoke access to the at least the portion of the personal data.

9. The computer-implemented method in claim 8 further comprising:
determining a protection score comprising:
comparing one or more active protections for the user to one or more potential protections for the user, wherein the one or more potential protections for the user are determined based in part on upcoming events of the user and demographic information of the user.

10. The computer-implemented method in claim 9 further comprising:
generating a risk score, wherein the risk score is generated based at least on a driving score and the protection score, and wherein the driving score is based at least on telematics data of the user.

11. The computer-implemented method in claim 8, wherein:
the digital wallet stores one or more safe driving certifications when a driving score of the user meets a score threshold; and
the driving score is based in part on telematics data of the user.

12. The computer-implemented method in claim 8 further comprising:
detecting upcoming events of the user by obtaining new documents of the user to be stored in the digital wallet; and
transmitting for display on the device of the user, an alert to update one or more protections for the user.

13. The computer-implemented method in claim 8 further comprising:
providing rewards to the user for taking one or more actions to protect the personal data of the user.

14. The computer-implemented method in claim 8, wherein the digital wallet further stores at least one of:
one or more payment methods for making purchases; or
one or more forms to enter personal information of the user.

15. A non-transitory computer-readable medium storing computing instructions for revoking access to personal information, the computing instructions, when run on one or more processors, causing the one or more processors to perform operations comprising:
obtaining personal data of a user;
storing the personal data in a digital wallet;
determining that at least a portion of the personal data in the digital wallet is subject to a data security risk; and
transmitting for display on a device of the user, an alert regarding the data security risk and a control to revoke access to the at least the portion of the personal data.

16. The non-transitory computer-readable medium of claim 15, wherein the operations further comprise:
determining a protection score comprising:
comparing one or more active protections for the user to one or more potential protections for the user, wherein the one or more potential protections for the user are determined based in part on upcoming events of the user and demographic information of the user.

17. The non-transitory computer-readable medium of claim 16, wherein the operations further comprise:
generating a risk score, wherein the risk score is generated based at least on a driving score and the protection score, and wherein the driving score is based at least on telematics data of the user.

18. The non-transitory computer-readable medium of claim 15, wherein:
the digital wallet stores one or more safe driving certifications when a driving score of the user meets a score threshold; and
the driving score is based in part on telematics data of the user.

19. The non-transitory computer-readable medium of claim 15, wherein:
the digital wallet stores one or more safe driving certifications when a driving score of the user meets a score threshold; and
the driving score is based in part on telematics data of the user.

20. The non-transitory computer-readable medium of claim 15, wherein:
(A) the operations further comprise:
detecting upcoming events of the user by obtaining new documents of the user to be stored in the digital wallet; and
transmitting for display on the device of the user, an alert to update one or more protections for the user;
(B) the operations further comprise providing rewards to the user for taking one or more actions to protect the personal data of the user; or
(C) the digital wallet further stores at least one of:
payment methods for making purchases; or
one or more forms to enter personal information of the user.
